(19) United States
(12) Patent Application Publication
(10) Pub. No.: US 2010/0104706 A1
(43) Pub. Date: Apr. 29, 2010

(54) Electrostatic de-worming technique

(76) Inventor: Billy R. Paddie, San Saba, TX (US)

Correspondence Address: William F. Ryann, Ste. 1629, 115E. Travis St., San Antonio, TX, 78205, US

(21) Appl. No.: 12/290,073

(22) Filed: Oct. 27, 2008

(51) Int. Cl. A23L 3/32; A23L 1/36; A23N 15/00

(52) U.S. Cl. 426/244; 426/632; 99/451

(57) ABSTRACT

Techniques for electrostatically de-worming agricultural products. The techniques may include inducing an electrical charge in a shelled agricultural product. The induced charge, for example, a positive charge, may selectively favor lighter or less dense contaminants associated with the agricultural product such as worm material. As such, the agricultural product with worm material contaminant may be exposed to an oppositely charged mechanism such as a rotatable negatively charged electrode. Thus, the lighter positively charged worm material may be effectively removed from the agricultural product by temporarily binding to the oppositely charged mechanism.

### BACKGROUND

Embodiments described relate to de-worming techniques and de-wormed products in the agricultural industry. In particular, de-worming of shelled agricultural products such as pecans via electrostatic de-worming techniques are described in detail.

### BACKGROUND OF THE RELATED ART

Following growth and collection, agricultural products may be treated, cleaned, sorted, and packaged in a variety of ways before reaching consumer product shelves. Over the course of such processing, particular attention may be placed on the separation of different material types of the agricultural product from one another. For example, the agricultural product may be a nut, thus requiring shelling in order to obtain the nut meat intended for the consumer. In fact, as detailed further below, the shelled nut itself may be of a variety such as pecan, which often requires application of further separation techniques in order to separate worm and nut material.

Separating pecan meat from shell debris is generally achieved by way of a water floatation system. That is, given that pecan meat is roughly more than about 50-70% oil, shelled pecan material, including pecan meat and shell debris alike, may be placed in a large tank. The tank may be filled with water and agitated in order to induce saturation of the relatively porous and less oily shell debris. Thus, the saturated shell debris will have a tendency to sink to the bottom of the tank, whereas the oily pecan meat will tend to float at the surface of the water. The floating pecan meat may then be advanced to a water table and eventually to a conveyor belt and drying bed. At this point, pecan meat may be further examined, for example, with an electronic eye for removal of substantially all remaining shell material.

The technique described above generally results in separation of substantially all shell material from the desired pecan meat product. However, in the case of native pecan, the pecan meat may remain contaminated with pecan worm material (e.g. pecan weevil larvae). Thus, as described below, another separation technique of de-worming may be applied in order to provide pecan meat of quality suitable for consumer shelves.

Separation or removal of worm material from pecan nut meat is generally achieved by way of utilization of a floatation system similar to the water floatation system described above. However, in this case, the floatation system is alcohol-based. That is, the potentially worm contaminated pecan meat may be placed in a tank that is filled with an alcohol containing medium. The alcohol containing medium may be a mixture of denatured alcohol and water. The denatured alcohol may be about 190 proof. Unlike the water floatation system described above, the utilization of an alcohol-based medium leads to the sinking of the pecan meat. On the contrary, however, the worm material will tend to float to the surface due to the makeup of the worm material which behaves like an air pocket.

Unfortunately, the cost of employing an alcohol based medium has increased substantially over the years. For example, the cost of denatured alcohol has risen from about $1.00 per gallon in the mid nineteen eighties to well over $5.00 a gallon as of the filing date of this patent document. This represents a 500% increase in the cost of providing the necessary fluid for the de-worming separation. Furthermore, the increase in cost is exacerbated by the fact that providing the fluid medium is itself an inexact science. That is, particular characteristics of the pecan meat, the variability in viscosity of the medium, and other factors can all have an affect on the amount of alcohol utilized. This leads to a fair amount of monitoring, trial and error that results in added processing time.

Further adding to the cost of the de-worming separation by way of an alcohol based floatation system is the fact that the resulting pecan meat product is often left with a fair amount of worm material contamination. As a result, the pecan meat product is generally floated multiple times in alcohol based mediums. Thus, depending on the parameters employed, the cost of de-worming separation may increase several fold by the time the final pecan meat product is obtained. It is therefore not uncommon to see de-worm processing run in the neighborhood of more than about $0.70 per pound of obtained pecan meat.

Ultimately, after more than about 5% meat loss and in spite of the considerable added expense, a substantially de-wormed pecan meat product may be obtained. The resulting pecan meat, like most any other agricultural product, may then undergo grading. In the case of pecan meat fit for consumer consumption, grades may range from a high of ‘fancy’ to a low of ‘standard’ (with a grade of ‘choice’ in between). The value of the pecan meat changes roughly 5-10% for each grade down from ‘fancy’.

Unfortunately, the de-worming technique employing an alcohol based medium often has a large impact on the above described pecan meat grading. That is, the greater the amount of exposure to the alcohol based medium, the greater the likelihood that the pecan meat will require downgrading. This is due to the negative impact on taste, color, and other characteristics of the pecan meat that result from exposure to the alcohol based medium. Furthermore, given that much of the pecan meat may require several passes through the medium before de-worming is completed, the adverse effect on the grade of the final product may be quite significant. That said, avoiding de-worming of the native pecan is not a viable option for the product when intended for consumer consumption.

### SUMMARY

A method of removing worm material is provided. The method may be electrostatic in nature. In one embodiment a charge is induced within agricultural product with a charge inducing mechanism. Worm material may then be separated from the agricultural product with an oppositely charged mechanism tuned to the worm material.

### BRIEF DESCRIPTION OF THE DRAWINGS

FIG. 1 is a perspective view of an embodiment of an electrostatic de-worming assembly.

FIG. 2 is an enlarged view of an embodiment of a charged agricultural product taken from 2-2 of FIG. 1.

FIG. 3 is a side view of an embodiment of a separation assembly incorporating the electrostatic de-worming assembly of FIG. 1.

FIG. 4 is a side view of an embodiment of a shelling assembly for providing shelled pre-charged agricultural product to the separation assembly of FIG. 3.

FIG. 5 is an enlarged view of an embodiment of de-wormed agricultural product taken from 5-5 of FIG. 3.

FIG. 6 is a flow-chart summarizing an embodiment of an electrostatic de-worming technique for use with agricultural product.

### DETAILED DESCRIPTION

Embodiments are described with reference to certain electrostatic de-worming techniques for application to agricultural products. In particular, de-worming of shelled pecan product is described in detail. However, techniques described herein may be utilized for de-worming of other forms of agricultural products, particularly nuts. Regardless, embodiments described herein focus on de-worming of agricultural product wherein an agricultural product is electrostatically charged and subsequently exposed to an opposite charge sufficient for substantially separating worm material from the product.

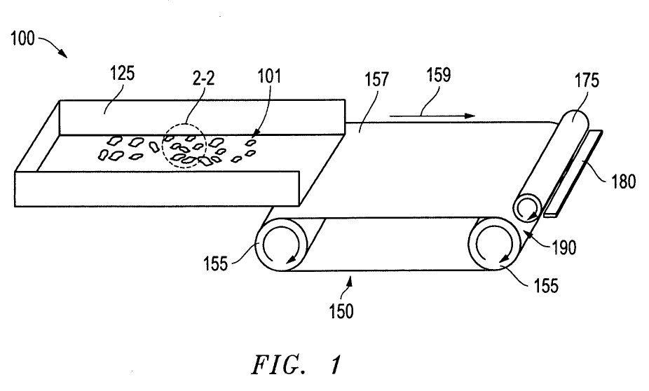

With reference now to FIG. 1, a perspective view of an electrostatic de-worming assembly 100 is depicted. The assembly 100 includes a charge inducing mechanism which may be in the form of a charge plate 125 for accommodating charged agricultural product 101. That is, the plate 125 may be configured to receive product 101 as detailed below and induce a charge therein. For example, in one embodiment, the plate 125 may be ‘hot’ in nature. That is, the charge plate 125 may be of an electrically conductive metal configured to act as a positive electrode for delivering a charge of up to 1 kW or more to the product 101. In the embodiment shown, the plate 125 is of stainless steel. However, other suitable materials may similarly be employed.

The charge plate 125 may be agitated and slightly angled toward a conveyor belt 150 so as to advance the charged product 101 through the de-worming assembly 100. More specifically, in the embodiment shown, the now positively charged product 101 may be advanced in the direction of arrow 159 and toward an oppositely charged mechanism (see collection electrode 175). As shown, the conveyor belt 150 is of a conventional nature with a belt 157 rotated about two rollers 155 in order to advance the product 101 as described. In FIG. 1, the rollers 155 are rotated in a clockwise direction in order to achieve advancement of the belt 150 in the direction of arrow 159.

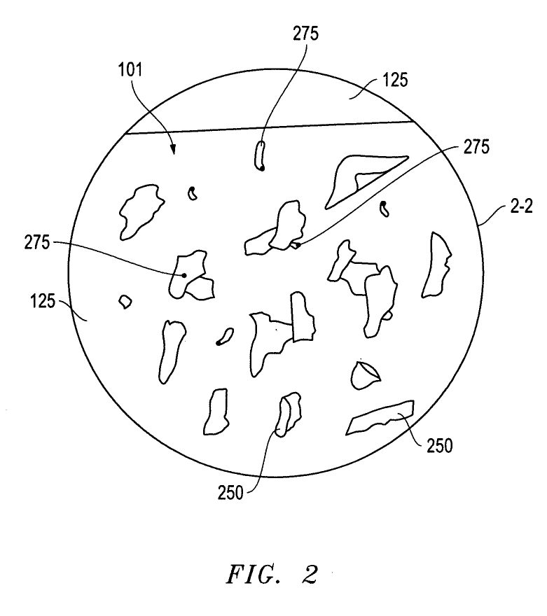

As indicated, the charged product 101 is advanced toward a collection electrode 175 which provides an electrostatic field for the substantial collection of worm material 275 (see FIG. 2). However, as depicted in FIG. 1, a gap 190 is present between the surface of the belt 157 and the outer surface of the collection electrode 175. In an embodiment where the charged product 101 includes primarily shelled pecan meat, the gap 190 may be less than about 0.5 inches wide, preferably about 0.375 inches. However, the size or distance covered by the gap 190 may vary. Regardless, the gap 190 will be sufficiently greater than the profile of the charged product 101 on average. In this manner, meat 250 of the charged product 101 may be allowed to pass beyond the electrode 175 (see FIG. 2).

Continuing now with added reference to FIG. 2, an enlarged view of the charged product 101 is shown. In particular, the charged product 101 may be made up primarily of the meat 250 of a shelled agricultural product, such as pecan nut meat. However, worm material 275, often found in native agricultural products may also be present. The worm material 275 is comparatively lighter than the meat 250, generally about half the density thereof. As a result, a greater amount of charge by weight may be found in the worm material 275. This may be thought of as inducing a relatively selective charge with respect to the worm material 275. With this in mind, the positively charged product 101 may be advanced toward a negatively charged collection electrode 175. In this embodiment, the electrode 175 may be of slight negative charge that is tailored to both attract and remove substantially all positively charged worm material 275 while substantially leaving behind the heavier meat 250 of the product 101.

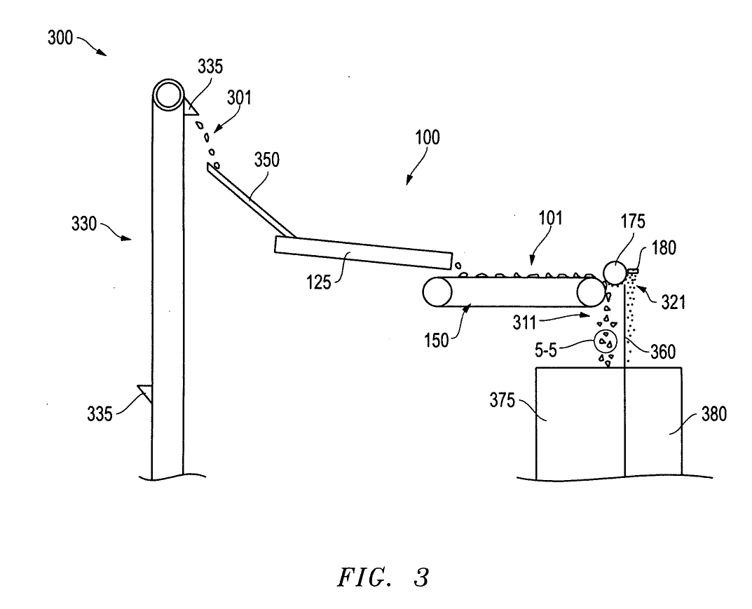

With brief added reference to FIG. 3, the tailored charge of the electrode 175 is apparent as separated product 311, made up primarily of the heavier meat 250, is dropped off the edge of the conveyor belt 250. At the same time, lighter more positively charged discard 321, made up of primarily worm material 275, is collected at the surface of the negatively charged collection electrode 175. Stated another way, the slight negative charge of the electrode 175 may be tailored to be of a strength sufficient for collection of worm material 275 but insufficient for collection of any substantial amount of the lesser charged heavier meat 250.

Continuing with reference to FIGS. 1-3, the negatively charged collection electrode 175 is configured to rotate in a counterclockwise direction (see FIG. 1). As such, discard 321 collected at the surface of the electrode 175 may be rotated away from the conveyor belt 150 and toward a sweeper bar 180. As shown, the sweeper bar 180 may run the length of the electrode 175 immediately adjacent thereto. Thus, discard 321 at the surface of the electrode 175 may be wiped or ‘swept’ therefrom. This leaves behind a clean surface of the electrode 175 for rotating back into interface with the gap 190 for collection of additional discard 321 from the charged product 101 (see FIG. 3).

Of particular note with respect to the above described embodiment of the electrostatic de-worming assembly 100 is the tunable nature of the electrode 175. That is, the charge of the electrode 175 may be finely tuned. This may be thought of similar to a household overhead light employing a dimmer light switch. In this manner, the negative charge may be increased, for example to increase the amount of discard 321 attained so as to reduce the likelihood of worm material 275 not being collected at the surface of the electrode 175.

The tunability of the electrode 175 may be leveraged in light of processing time and/or acceptable loss of meat 250. For example, the electrode 175 may be of a significant charge to reduce the number of passes employed in de-worming as detailed further below. However, the charge may be tuned lower and a greater number of passes employed in order to reduce the amount of meat 250 that ends up in the discard 321. Regardless, the amount of meat 250 from the charged product 101 that is ultimately lost to discard 321 may generally be less than about 1%.

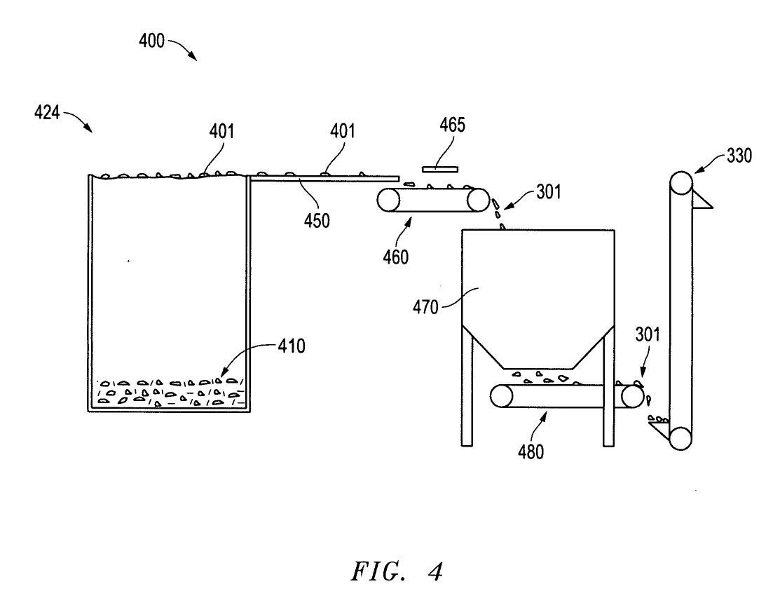

With particular reference to FIG. 3, a more detailed look at the electrostatic de-worming assembly 100 as part of a larger separation assembly 300 is depicted. In the embodiment shown, an elevator 330 with product compartments 335 is depicted. The elevator 330 may be of a conventional configuration for delivering shelled product 301 from a shelling assembly 400 of FIG. 4 toward the electrostatic de-worming assembly 100 as described above. A transition plate 350 is provided for receiving the shelled product 301 from the product compartments 335 of the elevator 330 and directing the product 301 toward the charge plate 125 of the de-worming assembly 100. As such, the shelled product 301 is converted to charged product 101 as detailed above.

With added reference to FIG. 2 and as also noted above, the charged product 101 may be positively charged and thus advanced along a conveyor belt 150 toward a negatively charged rotatable collection electrode 175. As such, lighter, more significantly and positively charged worm material 275 may be substantially separated from the product 101. That is, collection of discard 321, which is primarily worm material 275 may take place at the surface of the electrode 175. The rotation of the electrode 175 toward the sweeper bar 180 as shown, then results in cleaning of the discard 321 from the surface of the electrode 175.

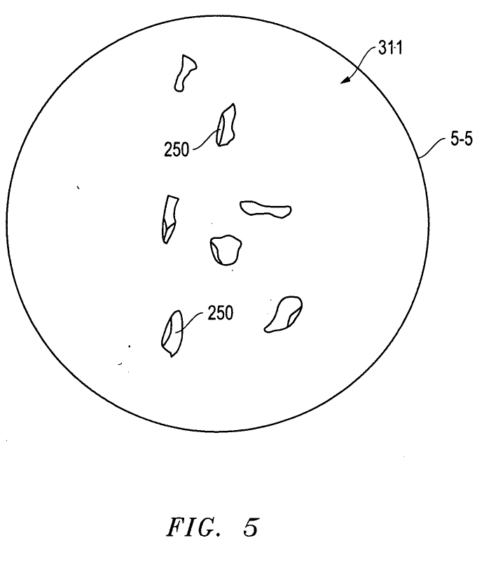

As shown in FIG. 3, the discard 321 falls below the sweeper bar 180 and into a discard container 380. With the discard 321 separated from the charged product 101, separated product 311 is now left which is made up primarily of meat 250 as depicted in FIG. 5. The separated product 311 may thus fall from the conveyor belt 150 and into a collection container 375 therebelow. A split plate 360 is provided immediately below the electrode 175 such that falling discard 321 is shielded off from falling separated product 321, thereby substantially preventing contamination of the collection container 375 with any re-introduction of discard. The separated product 311 may subsequently be removed from the collection container 375 and packaged for consumer consumption. Alternatively, further processing may ensue, for example by running the separated product 311 through the de-worming assembly 100 again to ensure complete removal of substantially all worm material 275.

The effectiveness of de-worming in this manner may be quite significant. For example, it would not be uncommon to have 90% or more of the worm material 275 removed from the charged product 101 through application of the described techniques. Furthermore, the resulting separated product 311 may be run through the de-worming assembly 100 multiple times as alluded to above. Indeed, it would not be uncommon to see in excess of 99% removal of worm material 275 with about two passes through the assembly 100 as described herein. Additionally, even with multiple passes, between about 1,000-2,000 lbs. per hour of shelled product 301 may be processed into separated product 311 as shown.

With particular reference to FIG. 4, a brief description is provided as to how the shelled product 301 is obtained. This shelled product 301 may be thought of as the pre-charged version of the charged product 101 depicted in FIGS. 1-3. In FIG. 4, an abbreviated depiction of an embodiment of a shelling assembly 400 is provided. The shelling assembly 400 includes a water tank 425 which may accommodate cracked shell agricultural product. More particularly, in the embodiment shown, wet product 401 and shell material 410 are depicted within the water tank 425. The shell material 410 may be saturated with water and naturally sink to the bottom of the tank 425 as shown. The wet product 401 however, may be primarily an oily nut such as pecan meat. Thus, the wet product 401 may float to the top of the tank 425. In the embodiment shown, the separation of product 401 and shell material 410 is depicted within a single water tank 425. However, this separation may be split between a separate saturation tank and shelling sink with a water transport pipe there-between.

Once at the top of the tank 425, the floating product 401 may be separated out to a water table 450 and then advanced to a conventional conveyor belt 460. At this point, the wet product 401 may be dried, generally down to about 4% moisture, via a conventional heater 465. This may be followed by application of conventional sizing and sorting techniques. For example, in one embodiment a conventional electronic eye sorting mechanism (not shown) may be employed to remove any product 401 deemed unacceptable based on color or other predetermined criteria. The belt 460 may move at a rate that is in line with the amount of heat, moisture and wet product 401 accommodated thereat. That is, by the time the wet product 401 leaves the belt 460 it may be substantially dried and transformed into the shelled product 301 as detailed above. Indeed, as depicted in FIG. 4, the shelled product 301 is dropped into a conventional hopper 470 from which it may be metered onto another conveyor belt 480 and advanced to the elevator 330 as detailed above with respect to FIG. 3.

Of note is the fact that the shelling depicted in FIG. 4 is similar to the de-worming as described with reference to FIGS. 1-3 in the noticeable absence of exposure to harsh chemicals, alcohol, or other processing fluids. That is, unlike, conventional shelling and de-worming which generally require repeated exposure to harsh processing fluids, the separated product 311 of the embodiments described herein may be obtained with exposure to no more than water, a minor amount of heat, and an electrostatic charge.

Ultimately, as depicted in FIG. 5, the end separated product 311 may be made up of primarily meat 250 with no significant amount of worm product or other contaminant therein. Furthermore due to the avoidance of exposure to harsh fluids and conditions during processing, the resulting quality, taste, and overall grade of the product 311 may be substantially enhanced.

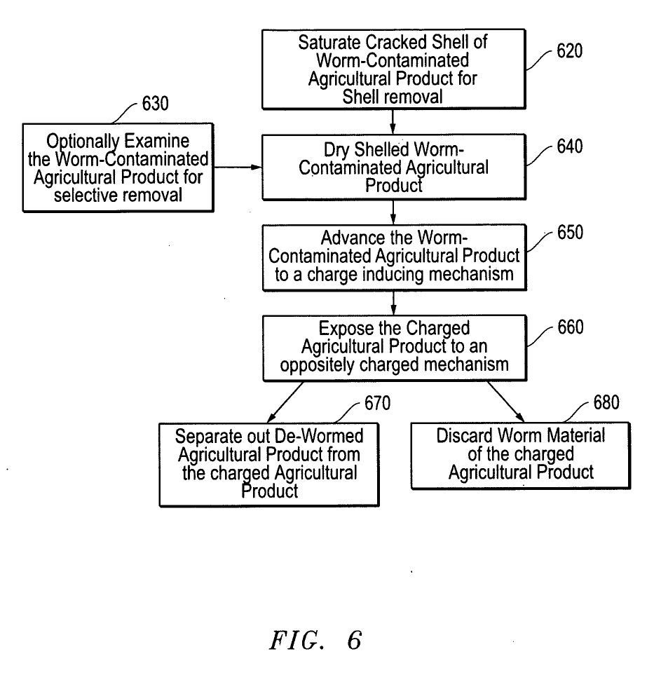

Referring now to FIG. 6, a flow-chart is depicted summarizing an embodiment of shelling and de-worming an agricultural product according to electrostatic techniques detailed hereinabove. That is, initial shelling, and drying of a worm-contaminated agricultural product such as pecans may take place as indicated at 620 and 640. The shelling may include saturation of the cracked shell about the product as noted. Additionally, visual inspection of the shelled agricultural product may take place as indicated at 630. This may be aided through use of an electronic eye to identify portions of the agricultural product for selective removal and discard based on a predetermined criteria such as color.

As indicated at 650, once the worm-contaminated agricultural product is shelled it may be advanced to a charge inducing mechanism such as a charge plate. In this manner, a charge which tends to favor worm material of the agricultural product may be induced therein. Thus, the product may be exposed to an oppositely charged mechanism as noted at 660, such as a rotatable electrode. As such, de-wormed agricultural product may be separated out from the charged agricultural product as indicated at 670. Simultaneously, as noted at 680, worm material of the charged agricultural product may be discarded.

The de-worming techniques described hereinabove achieve substantially complete removal of worm material from agricultural products such as pecan meat without exposure to an alcohol based medium. As such, sacrifice to color, taste, quality and overall grade due to processing is avoided. Additionally, the avoidance of alcohol may significantly reduce overall processing expenses.

The preceding description has been presented with reference to presently preferred embodiments. Persons skilled in the art and technology to which these embodiments pertain will appreciate that alterations and changes in the described structures and methods of operation may be practiced without meaningfully departing from the principle, and scope of these embodiments. For example, embodiments described hereinabove involve de-worming of agricultural product. However other lighter or less dense selectively chargable contaminant within the product such as dust may be separated from the agricultural product according to the electrostatic techniques described herein. Furthermore, the foregoing description should not be read as pertaining only to the precise structures described and shown in the accompanying drawings, but rather should be read as consistent with and as support for the following claims, which are to have their fullest and fairest scope.

I claim:

1. An electrostatic de-worming assembly comprising:
a charge inducing mechanism for inducing a charge in an agricultural product; and
an oppositely charged mechanism adjacent said charge inducing mechanism for collection of contaminant from the charged agricultural product.

2. The electrostatic de-worming assembly of claim 1 wherein the charge is a positive charge and said oppositely charged mechanism comprises a negatively charged electrode for forming an electrostatic field.

3. The electrostatic de-worming assembly of claim 1 wherein said charge inducing mechanism comprises a charge plate of electrically conductive metal.

4. The electrostatic de-worming assembly of claim 1 further comprising a conveyor mechanism positioned between said charge inducing mechanism and said oppositely charged mechanism for advancing the charged agricultural product from said charge inducing mechanism toward said oppositely charged mechanism.

5. The electrostatic de-worming assembly of claim 4 wherein the agricultural product includes pecan nut meat and the advancing is to within about 0.5 inches of said oppositely charged mechanism.

6. The electrostatic de-worming assembly of claim 4 wherein said oppositely charged mechanism is rotatable relative to said conveyor mechanism for collection of the contaminant at a surface thereof.

7. The electrostatic de-worming assembly of claim 6 further comprising a sweeper bar adjacent said oppositely charged mechanism for discarding the contaminant from the surface thereof.

8. The electrostatic de-worming assembly of claim 7 further comprising a splitter plate disposed adjacent said oppositely charged mechanism between said sweeper bar and said conveyor mechanism to shield discarded contaminant from remaining agricultural product.

9. A substantially contaminant-free agricultural product comprising positively charged nut meat exposed to a negatively charged electrode for contaminant removal therefrom.

10. The substantially contaminant-free agricultural product of claim 9 wherein the nut meat is pecan nut meat and the contaminant is worm material.

11. An electrostatic method of de-worming an agricultural product, the method comprising:
inducing a charge in the agricultural product with a charge inducing mechanism; and
separating contaminant from the agricultural product with an oppositely charged mechanism.

12. The method of claim 11 wherein said inducing further comprises substantially selectively charging the contaminant with a positive charge.

13. The method of claim 11 wherein said separating further comprises tuning a negative electrostatic field of said oppositely charged mechanism to the positively charged contaminant.

14. The method of claim 11 wherein the agricultural product includes pecan nut meat and the contaminant is worm material.

15. The method of claim 14 wherein said inducing and said separating take place at a rate of between about 1,000 lbs. per hour and about 2,000 lbs. per hour of the agricultural product.

16. The method of claim 14 further comprising:
removing shell material from the pecan nut meat through water saturation; and
drying the pecan nut meat prior to said inducing.

17. The method of claim 16 further comprising optically examining the pecan nut meat for discard based on a predetermined criteria prior to said inducing.

18. The method of claim 17 wherein the predetermined criteria includes color.

19. An assembly for shelling and de-worming a nut, the assembly comprising:
a shelling unit for water saturation removal of shell material from the nut; and
an electrostatic de-worming unit with charge inducing and oppositely charged mechanisms for exposing of the nut thereto for contaminant removal.

20. The assembly of claim 19 further comprising:
a water table adjacent said shelling unit for isolation of the nut; and
a dryer adjacent the water table for drying the nut prior to the exposing.
